(19) United States
(12) Patent Application Publication
(10) Pub. No.: US 2003/0026571 A1
(43) Pub. Date: Feb. 6, 2003

(54) Method of reducing sidewall roughness of a waveguide

(76) Inventor: Michael Bazylenko, Eveleigh (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/919,104

(22) Filed: Jul. 31, 2001

(51) Int. Cl. G02B 6/10

(52) U.S. Cl. 385/129; 385/132; 216/24

(57) ABSTRACT

The invention provides a method of modifying a planar waveguide core formed on a planar substrate and having at least one rough sidewall. The method comprises the steps of forming an overlayer having substantially the same refractive index as the waveguide core over each rough sidewall of the waveguide core so as to smooth over the sidewall roughness; and etching back the overlayer to form a desired waveguide structure with reduced sidewall roughness, wherein the rough sidewalls of the original waveguide core remain substantially coated with overlayer material in the desired waveguide structure. The roughness of the original sidewalls of the waveguide core is effectively reduced by leaving their coated with the overlayer material, which has been etched back. This leaves smoother sidewalls in the desired waveguide structure when compared with the original sidewalls of the waveguide core. The invention is particularly useful for reducing sidewall scattering losses in planar waveguide optical amplifiers.

### FIELD OF THE INVENTION

The present invention relates broadly to a method of modifying a planar waveguide core, a waveguide core modified by the method, and to a waveguide.

### BACKGROUND OF THE INVENTION

When a core of a planar waveguide, such as a channel waveguide, is shaped by photolithographically-defined etching, a degree of sidewall roughness is encountered in the resultant waveguide due to roughness at the edge of the photoresist used in the etching. This sidewall roughness can cause undesirable optical scattering losses in the waveguide.

Roughness-induced scattering losses increase as the contrast in refractive index between the core and a cladding formed over the core increases, due to tighter optical mode confinement with increasing contrast in refractive index.

At the same time, for many applications such as in the production of planar optical amplifiers, it is beneficial to increase the contrast in refractive index between the core and the cladding in order to increase mode confinement to maximise gain, and to increase optical circuit density on the wafer. Therefore, the disadvantages associated with sidewall roughness are particularly undesirable in such applications.

In at least preferred embodiments, the present invention seeks to provide a method of modifying a waveguide core to effectively reduce sidewall roughness.

### SUMMARY OF THE INVENTION

In accordance with a first aspect of the present invention there is provided a method of modifying a planar waveguide core formed on a planar substrate and having at least one rough sidewall, the method comprising the steps of forming an overlayer having substantially the same refractive index as the waveguide core over each rough sidewall of the waveguide core so as to smooth over the sidewall roughness; and etching back the overlayer to form a desired waveguide structure with reduced sidewall roughness, wherein the rough sidewalls of the original waveguide core remain substantially coated with overlayer material in the desired waveguide structure.

Accordingly, the roughness of the original sidewalls of the waveguide core is effectively reduced by leaving them coated with the overlayer material, which has been etched back. This leaves smoother sidewalls in the desired waveguide structure when compared with the original sidewalls of the waveguide core.

In one embodiment, the steps of forming and etching the overlayer are conducted in a manner which leaves only the original rough sidewalls substantially covered with the overlayer material.

Alternatively, the steps, of forming and etching the overlayer may be conducted in a manner which leaves the waveguide core covered with the overlayer material.

The waveguide core may be in the form of a channel waveguide.

Alternatively, the waveguide core may be in the form of a rib waveguide.

The desired waveguide structure may be substantially in the form of a channel waveguide.

The desired waveguide structure may be substantially in the form of a rib waveguide.

Where the desired waveguide structure comprises a rib waveguide structure, the steps of forming and etching back the overlayer may be conducted in a manner which leaves the waveguide core covered to an extent required to achieve a desired thickness of the resulting rib waveguide structure.

The method may further comprise the step of depositing a cladding layer over the desired waveguide structure.

The substrate may comprise a buffer layer formed on a substrate wafer.

The waveguide core may be doped with a gain medium. The overlayer may be doped with a gain medium. In one embodiment, the over-layer and core are both doped with a gain medium. The gain medium may comprise a rare earth element, such as erbium and/or ytterbium.

The overlayer material may be the same as the waveguide core material.

The waveguide core may be aluminium-oxide-based.

The buffer layer and/or the cladding layer may be silica-based.

The step of etching may comprise ion milling and/or reactive ion etching.

In accordance with a second aspect of the present invention there is provided a waveguide structure comprising a waveguide core modified in accordance with the first aspect of the present invention.

In accordance with a third aspect of the present invention there is provided a waveguide comprising a light-guiding element formed on a planar substrate, the light-guiding element comprising a core having at least one rough sidewall and an etched-back overlayer coating on each rough sidewall, the overlayer having substantially the same refractive index ass the core

In one embodiment, the thickness of the etched-back overlayer coating on each rough sidewall is at least as great as a minimum thickness required to lessen the roughness of each rough sidewall.

### BRIEF DESCRIPTION OF THE DRAWINGS

Embodiments of the present invention will now be described, by way of example only, with reference to the accompanying drawings.

FIGS. 1A-D are schematic cross-sectional drawings illustrating a method of modifying a waveguide embodying the present invention.

FIGS. 2A-D arc schematic cross-sectional drawings illustrating another method of modifying a waveguide embodying the present invention.

FIGS. 3A-D are schematic cross-sectional drawings illustrating another method of modifying a waveguide embodying the present invention.

FIG. 4 is a schematic cross-sectional drawings illustrating a planar optical amplifier structure embodying the present invention.

### DETAILED DESCRIPTION OF THE EMBODIMENTS

The preferred embodiments described provide a method of modifying a waveguide core to effectively reduce roughness of sidewalls in the original waveguide to form a desired waveguide structure having smooth sidewalls.

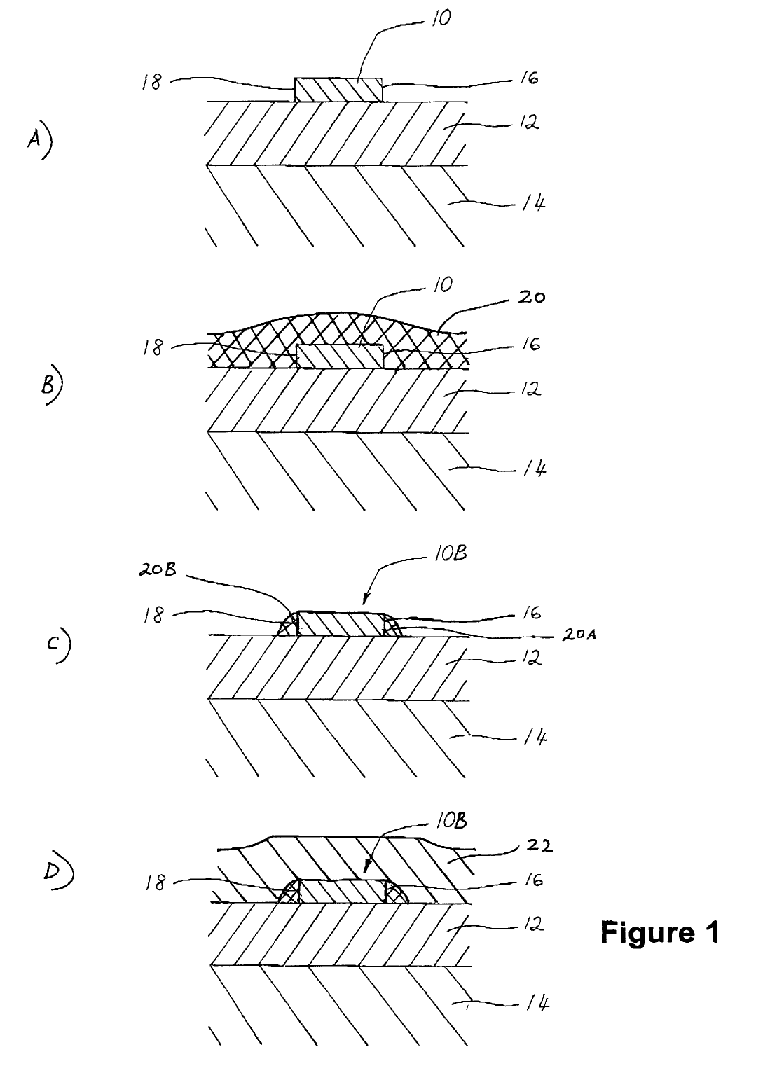

In FIG. 1A, an aluminium-oxide-based channel waveguide 10 is formed on a silica-based buffer layer 12, which is in turn formed on a silicon wafer 14. The channel waveguide 10 has sidewalls 16, 18 which exhibit a degree of roughness as a result of a photolithoraphically-defined etching process used in the formation of the channel waveguide 10. In the first step (FIG. 1B) of a method of modifying the channel waveguide 10, an overlayer 20 is deposited over the channel waveguide 10. The overlayer is composed of a material which has substantially the same refractive index as the channel waveguide 10. The overlayer 20 is deposited to a thickness sufficient to smooth over the roughness of the original sidewalls 16, 18, in other words, to a thickness sufficient such that the roughness is not transferred onto the outer surface 21 of the overlayer 20.

In a next processing step, the overlayer 20 is then etched by ion milling using argon ions (or ions of other inert gases) until, as shown in FIG. 1C, only the original sidewalls 16, 18 of the channel waveguide 10 remain coated with overlayer material 20A, 20B respectively, resulting in modified channel waveguide 10B. Since the initial overlayer 20 was deposited to a thickness sufficient to smooth over the roughness of the sidewall 16, 18 (FIG. 1B), the outer surfaces of the remaining overlayer coatings 20A, 20B exhibit a relatively smooth outer surface after the ion milling. Furthermore, since the overlayer material was chosen to have substantially the same refractive index as the channel waveguide material, the resultant channel waveguide 10B can now function as a channel waveguide with smooth sidewalls, i.e. reduced optical losses when compared with the initial channel waveguide 10.

In a final step shown in FIG. 1D a cladding layer 22 is deposited over the channel waveguide 10B to complete the overall waveguide structure.

It can be seen that in the method of the present invention there are two parameters which affect sidewall roughness in the modified waveguide: the thickness of the etched-back overlayer; and the etching process itself. Preferably, both of these parameters are controlled in a manner which minimiscs sidewall roughness for a given overlayer material and waveguide structure.

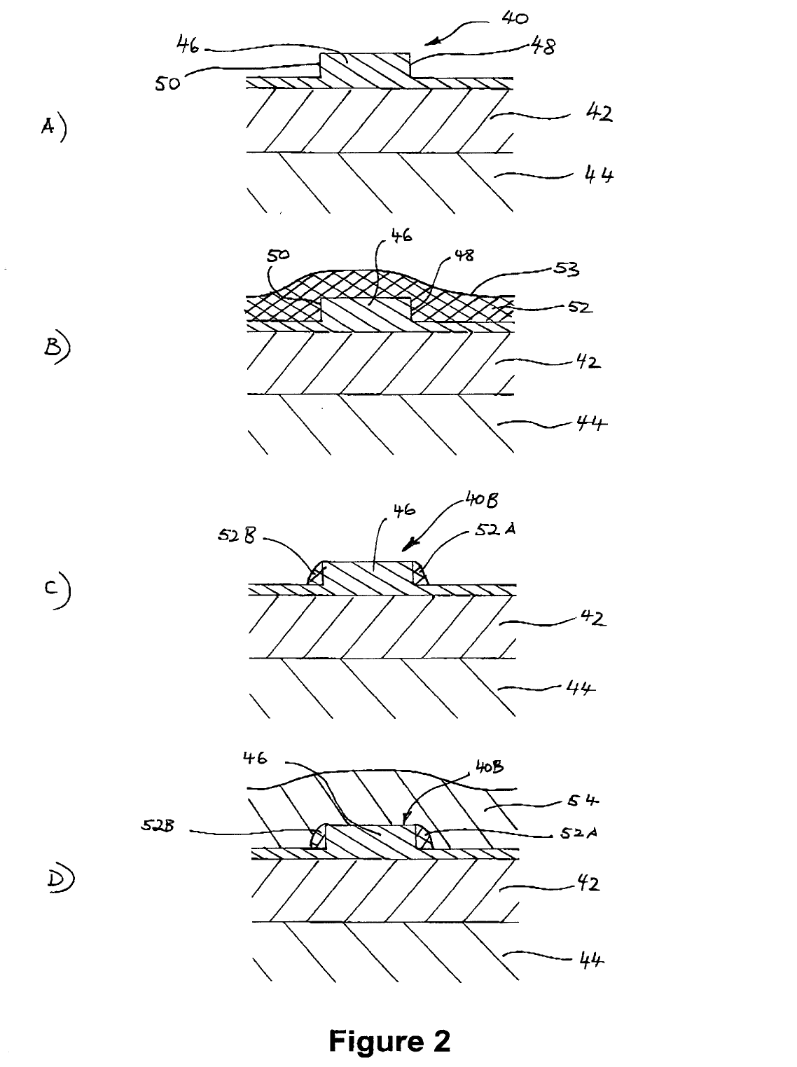

FIGS. 2A-D show an embodiment of the present invention when applied to an initial waveguide core in the form of a rib waveguide. In FIG. 2A, an aluminum-oxide-based rib waveguide 40 has been formed on a silica-based buffer layer 42, which is in turn formed on a silicon wafer 44. The rib portion 46 of the waveguide rib 40 has been formed utilising photolithographically-defined etching, thus resulting in rough sidewalls 48, 50 of the rib portion 46.

In the first step (Fief 2B) of a method of modifying the rib waveguide 40, an overlayer 52 is deposited over the rib waveguide 40 as shown in FIG. 2B. The overlayer is composed of a material which has substantially the same refractive index as the rib waveguide 40. The overlayer 52 is deposited to a thickness sufficient to smooth over the roughness of the original sidewalls 48, 50, in other words to a thickness sufficient such that the roughness is not transferred onto the outer surface 53 of the overlayer 52.

In a next processing step, the overlayer 52 is then etched by ion milling using argon ions (or ions of other inert gases) until, as shown in FIG. 2C, only the original sidewalls 49, 50 of the rib waveguide 40 remain coated with coatings of overlayer material 52A, 52B respectively, resulting in modified rib waveguide 40B Since the initial overlayer 52 was deposited to a thickness sufficient to smooth out the roughness of the sidewall 48, 50 (FIG. 2B), the outer surfaces of the remaining overlayer coatings 52A, 52B exhibit a relatively smooth outer surface after the ion milling. Furthermore, since the overlayer material was chosen to have substantially the same refractive index as the rib waveguide material, the resultant rib waveguide 40B can now function as a rib waveguide 40B with smooth sidewalls, i.e. with reduced optical losses when compared with the initial rib waveguide 40.

In a final step shown in FIG. 2D a cladding layer 54 is deposited over the rib waveguide 40B to complete the overall waveguide structure.

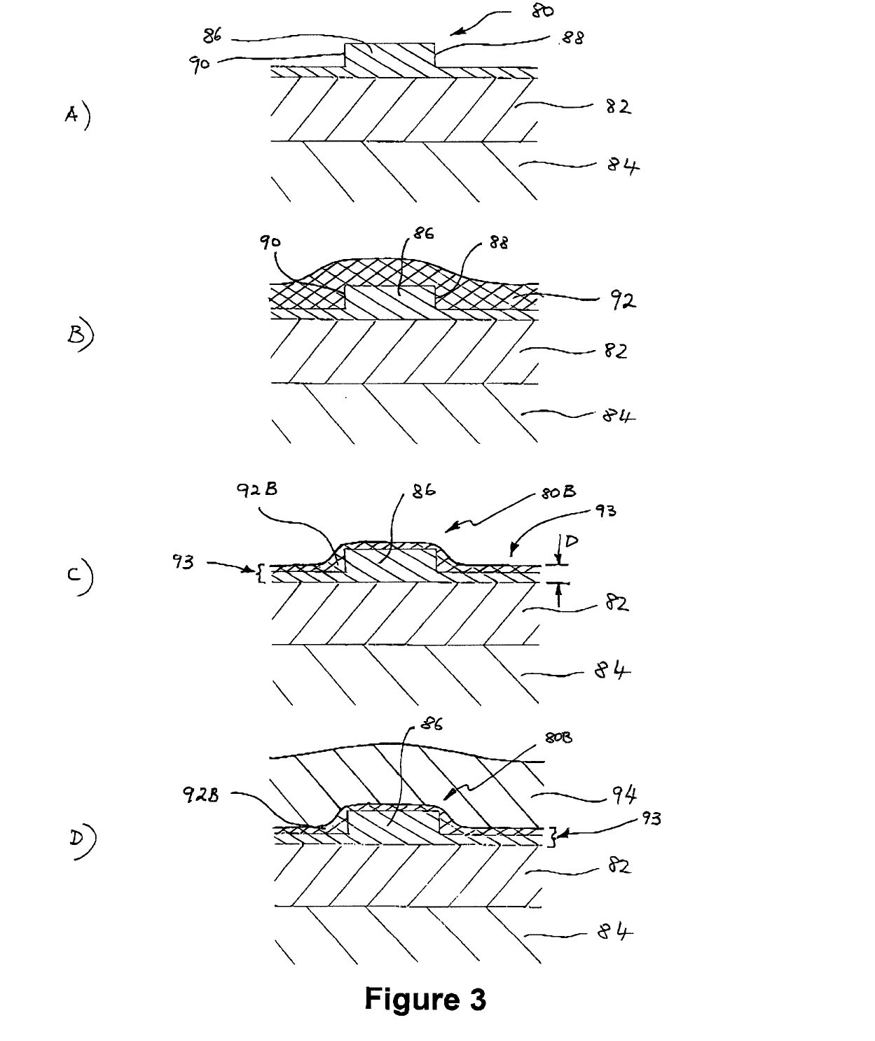

Another embodiment of the present invention will now be described with references to FIGS. 3A-D. In FIG. 3A, an aluminium-oxide-based rib waveguide 80 is formed on a silica-based buffer layer 82, which is in turn formed on a silicon wafer 84. Again, a rib portion 86 of the waveguide rib 80 has rough sidewalls 88, 90 as a result of utilising photolithographically-defined etching in the formation of the rib waveguide 80.

In the first step (FIG. 3B), an overlayer 92 is deposited over the rib waveguide 80 to a thickness sufficient to smooth over the roughness of the original sidewalls 88, 90. The overlayer 92 is composed of a material which has substantially the same refractive index as the rib waveguide 80.

In a subsequent step, the deposited overlayer 92 is etched back until peripheral regions 93 either side of the rib 86 have a predetermined overall thickness D, comprising both the original rib material 80 and etched-back overlayer material for which optical confinement in the rib 86 is optimal. As shown in FIG. 3C, this leaves the entire original rib waveguide 80 covered with a coating of the etched-back overlayer 92B, in contrast with the embodiments described above in which only the sidewalls are coated.

It is noted here that the optical confinement of the waveguide SOB can be controlled independently of the sidewall roughness by selecting the appropriate thickness D of the peripheral region 93. If necessary, the overlayer material can be entirely etched away from the peripheral region 93, as shown in FIG. 2C. This embodiment therefore provides a rib waveguide design with high design flexibility.

Again in a final step shown in FIG. 3D, a cladding layer 94 is deposited over the rib waveguide structure 80B to complete the desired waveguide.

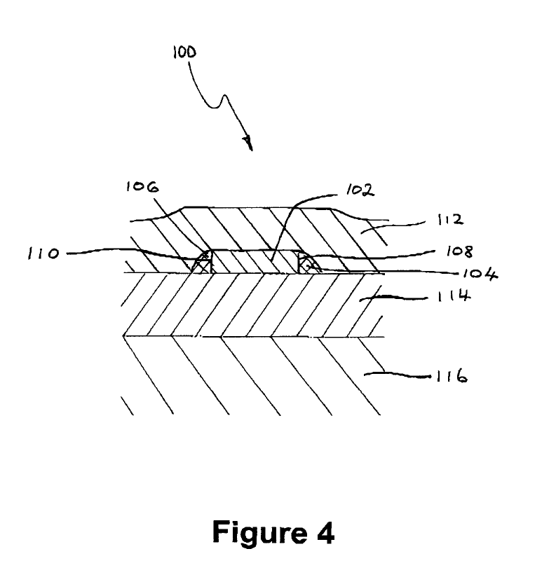

The present invention has many applications, including in the construction of a planar optical amplifier 100 shown in FIG. 4. The amplifier structure 100 comprises a channel waveguide core 102 which is doped with a gain medium for effecting optical amplification of a light signal travelling along the waveguide core 102. The amplifier structure 100 further comprises waveguide regions 104, 106 which cover sidewalls 108, 110 respectively of the waveguide core 102 to eliminate roughness-induced scattering losses. The waveguide regions 104, 106 are formed from a material chosen such that its refractive index is the same as the refractive index of the waveguide core 102. In the embodiment shown in FIG. 4, the same material (aluminum oxide) and the same gain medium (erbium) have been used for the formation of the regions 104, 106 and the waveguide core 102. However, it will be appreciated by the person skilled in the art that the regions 104, 106 may be formed from another material and may not incorporate the same dopants as the core 102, provided that the refractive index is substantially matched to the refractive index of the waveguide core 102.

The amplifier structure 100 further comprises a silica-based cladding layer 112 and a silica-based buffer layer 114, both having a refractive index lower than the refractive index of the waveguide core 102 and the waveguide regions 104, 106. The buffer layer 114 is in turn formed on a silicon wafer 116.

It will be appreciated by the person skilled in the art that numerous modification and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A method of modifying a planar waveguide core formed on a planar substrate and having at least one rough sidewall, the method comprising the steps of:
forming an overlayer having substantially the same refractive index as the waveguide core over each rough sidewall of the waveguide core so as to smooth over the sidewall roughness; and
etching back the overlayer to form a desired waveguide structure with reduced sidewall roughness,
wherein the rough sidewalls of the original waveguide core remain substantially coated with overlayer material in the desired waveguide structure.

2. A method as claimed in claim 1, wherein the steps of forming and etching the overlayer are conducted in a manner which leaves only the original rough sidewalls (substantially covered with the overlayer material.

3. A method as claimed in claim 1, wherein the steps of forming and etching the overlayer are conducted in a manner which leaves the waveguide core covered with the overlayer material.

4. A method as claimed in claim 1, wherein the waveguide core is in the form of a channel waveguide.

5. A method as claimed in claim 1, wherein the waveguide core is in the form of a rib waveguide.

6. A method as claimed in claim 1, wherein the desired waveguide structure is substantially in the form of a channel waveguide.

7. A method as claimed in claim 1, wherein the desired waveguide structure is substantially in the form of a rib waveguide.

8. A method as claimed in claim 1, wherein, where the desired waveguide structure comprises a rib waveguide structure, the steps of forming and etching back the overlayer are conducted in a manner which leaves the waveguide core covered to an extent required to achieve a desired thickness of the resulting rib waveguide structure.

9. A method as claimed in claim 1, wherein the method further comprises the step of depositing a cladding layer over the desired waveguide structure.

10. A method as claimed in claim 1, wherein the substrate comprises a buffer layer formed on a substrate wafer.

11. A method as claimed in claim 1, wherein the waveguide core is doped with a first gain medium.

12. A method as claimed in claims 1, wherein the overlayer is doped with a gain medium.

13. A method as claimed in claim 1, wherein the overlayer and waveguide core are both doped with a gain medium.

14. A method as claimed in claim 1, wherein the overlayer material is the same as the waveguide core material.

15. A method as claimed in claim 1, wherein the waveguide core is aluminium-oxide-based.

16. A method as claimed in claim 1, wherein the buffer layer is silica-based.

17. A method as claimed in claim 9, wherein the cladding layer is silica-based.

18. A method as claimed in claim 1, wherein the step of etching comprises ion milling and/or reactive ion etching.

19. A method as claimed in claim 1, wherein the etching is carried out using an etching technique selected from a group comprising ion milling, reactive ion etching, and wet etching, the etching technique being selected so as to minimise surface roughness on the etched overlayer material.

20. A method as claimed in claim 1, wherein the step of etching is terminated when the etched-back overlayer has an optimal thickness for minimising sidewall roughness in the desired waveguide structure.

21. A waveguide structure comprising a waveguide core modified in accordance with claim 1.

22. A waveguide comprising a light-guiding element formed on a planar substrate, the light-guiding element comprising a core having at least one rough sidewall and an etched-back overlayer coating on each rough sidewall, the overlayer having substantially the same refractive index as the core.

23. A waveguide as claimed in claim 22, wherein the thickness of the etched-back overlayer coating on each rough sidewall is at least as great as a minimum thickness required to lessen the roughness of each rough sidewall of the core.
